(19) United States
(12) Patent Application Publication
(10) Pub. No.: US 2023/0071822 A1
(43) Pub. Date: Mar. 9, 2023

(54) ELECTRONIC BRAKE SYSTEM AND CONTROL METHOD THEREFOR

(71) Applicant: MANDO CORPORATION, Gyeonggi-do (KR)

(72) Inventor: Yulshin PARK, Gyeonggi-do (KR)

(21) Appl. No.: 17/797,427

(22) PCT Filed: Feb. 4, 2021
(86) PCT No.: PCT/KR2021/001467

§ 371 Date: Aug. 4, 2022

(30) Foreign Application Priority Data
Feb. 4, 2020 (KR) 10-2020-0013267

(51) Int. Cl. B60T 8/40; B60T 13/68; B60T 13/74; B60T 7/04; B60T 8/172; B60T 8/32

(52) U.S. Cl. CPC B60T 8/4081; B60T 13/686; B60T 13/745; B60T 7/042; B60T 8/172; B60T 8/3205; B60T 8/4009; B60Y 2400/301; B60Y 2400/306; B60Y 2400/81

(57) ABSTRACT

Provided is an electronic brake system including: a hydraulic pressure supply device including a motor, and configured to generate a hydraulic pressure by rotating the motor to move a piston in a first direction or a second direction; a hydraulic circuit configured to guide the hydraulic pressure generated by the hydraulic pressure supply device to a wheel cylinder; a motor position sensor configured to detect a rotation of the motor; a pressure sensor configured to detect a hydraulic pressure of the hydraulic circuit; and a controller configured to identify a position of the piston based on the rotation of the motor, and if the detected hydraulic pressure is greater than or equal to a reference pressure, identify whether a target pressure is securable based on the position of the piston, and control a direction change of the piston based on whether the predetermined target pressure is securable.

### TECHNICAL FIELD

The present disclosure relates to an electronic brake system and an operating method thereof, and more specifically, to an electronic brake system for generating a braking force using an electrical signal corresponding to a displacement of a brake pedal and a method of controlling the same.

### BACKGROUND ART

In general, an electronic brake system includes a hydraulic pressure supply device for supplying pressure to wheel cylinders by receiving a driver's braking intention as an electrical signal from a pedal displacement sensor that detects a displacement of a brake pedal when the driver applies the brake pedal.

In the hydraulic pressure supply device, a motor operates according to a pedal effort of the brake pedal to generate a braking pressure, in which case, the braking pressure is generated as a rotational force of the motor is converted into a linear motion and accordingly a piston is pressed.

### DISCLOSURE

### Technical Problem

The present disclosure is directed to providing an electronic brake system capable of changing the directions of a piston and a method of controlling the same.

### Technical Solution

One aspect of the present invention provides an electronic brake system including: a hydraulic pressure supply device including a motor, and configured to generate a hydraulic pressure by rotating the motor to move a piston in a first direction or a second direction; a hydraulic circuit configured to guide the hydraulic pressure generated by the hydraulic pressure supply device to a wheel cylinder; a motor position sensor configured to detect a rotation of the motor; a pressure sensor configured to detect a hydraulic pressure of the hydraulic circuit; and a controller configured to identify a position of the piston based on the rotation of the motor, and if the detected hydraulic pressure is greater than or equal to a reference pressure, identify whether a target pressure is securable based on the position of the piston, and control a direction change of the piston based on whether the predetermined target pressure is securable.

The controller may be configured to identify a target stroke change amount of the piston for securing the target pressure, and identify whether the predetermined target pressure is securable based on the position of the piston and the target stroke change amount.

The controller may be configured to, if the position of the piston is located within a reference range in which the target stroke change amount is securable in a moving direction of the piston, identify that the target pressure is securable.

The controller may be configured to, determine a range in a direction opposite to the moving direction of the piston with respect to a reference position for securing the target stroke change amount as the reference range in which the target stroke change amount is securable.

The electronic brake system may further include a storage configured to store a characteristic map of a stroke of the piston and hydraulic pressure, wherein the controller may be configured to determine the target stroke change amount of the piston corresponding to the target pressure based on the characteristic map.

The controller may be configured to, if the target pressure is securable, control the motor such that the moving direction of the piston may be maintained.

The controller may be configured to, if the target pressure is not securable, control the motor such that the moving direction of the piston is changed.

The controller may be configured to determine whether the target pressure is securable based on the position of the piston if a vehicle speed is greater than or equal to a predetermined reference speed.

The controller may be configured to determine whether the target pressure is securable based on the position of the piston if an anti-lock brake system (ABS) control or an electronic stability control system (ESC) control is performed.

The controller may be configured to determine whether the target pressure is securable based on the position of the piston if a user input is received.

The controller may be configured to determine whether the target pressure is securable based on the position of the piston if a hydraulic pressure of a pressurized medium discharged as the piston moves in a forward direction is greater than or equal to the reference pressure.

The hydraulic circuit may further include a hydraulic control unit including a first hydraulic circuit configured to control a hydraulic pressure transferred to a first wheel cylinder and a second hydraulic circuit configured to control a hydraulic pressure transferred to a second wheel cylinder, wherein the hydraulic control unit may include: a first valve configured to control a flow of pressurized medium from a first pressure chamber located at one side of the piston and a second valve configured to control a flow of pressurizing medium from a second pressure chamber located at an other side of the piston.

The electronic brake system may further include a valve driver configured to open or close the first and second valves, wherein the controller is configured to, if the detected hydraulic pressure is greater than or equal to the reference pressure, control the valve driver to open the first valve and the second valve.

Another aspect of the present invention provides an electronic brake system including: a hydraulic pressure supply device including a motor, and configured to generate a hydraulic pressure by rotating the motor to move a piston in a first direction or a second direction; a hydraulic circuit configured to guide the hydraulic pressure generated by the hydraulic pressure supply device to a wheel cylinder; a motor position sensor configured to detect a rotation of the motor; and a controller configured to, if an operation mode is a high-pressure mode, determine whether a predetermined target pressure is securable based on a position of the piston, determine a moving direction of the piston for transferring a hydraulic pressure to the wheel cylinder based on whether the predetermined target pressure is securable, and control the hydraulic pressure supply device to move the piston in the determined moving direction.

The electronic brake system may further include a pressure sensor configured to detect a hydraulic pressure of the hydraulic circuit, wherein the controller may be configured to determine the operation mode as the high-pressure mode based on at least one of the detected hydraulic pressure, a vehicle speed, whether an anti-lock brake system (ABS) control is performed, whether an electronic stability control system (ESC) control is performed, or an input of a user.

The hydraulic circuit may include: a first valve configured to control a flow of pressurized medium from a first pressure chamber located at one side of the piston and a second valve configured to control a flow of pressurizing medium from a second pressure chamber located at an other side of the piston.

The electronic brake system may further include a valve driver configured to open or close the first and second valves, wherein the controller may be configured to, if the hydraulic pressure is greater than or equal to a predetermined reference pressure, control the valve driver to open the first valve and the second valve.

Another aspect of the present invention provides a method of controlling an electronic brake system, the method including: generating a hydraulic pressure by rotating a motor to move a piston in a first direction or a second direction; detecting rotation of the motor; detecting the generated hydraulic pressure; identifying a position of the piston based on the rotation of the motor; if the detected hydraulic pressure is greater than or equal to a reference pressure, identifying whether a target pressure is securable based on the position of the piston; and changing a moving direction of the piston based on whether the predetermined target pressure is securable.

The identifying of whether the target pressure is securable may include: identifying a target stroke change amount of the piston for securing the target pressure; and identifying whether the target pressure is securable based on the position of the piston and the target stroke change amount.

The changing of the moving direction of the piston may include: if the target pressure is securable, controlling the motor such that the moving direction of the piston is maintained; and if the target pressure is not securable, controlling the motor such that the moving direction of the piston is changed.

### Advantageous Effects

According to the electronic brake system according to an aspect and the method of controlling same efficiently generate a braking pressure, so that the performance and operational reliability of the product can be improved. In addition, a high-pressure braking pressure can be stably generated.

### DESCRIPTION OF DRAWINGS

FIG. 1 is a hydraulic circuit diagram illustrating an electronic brake system according to an embodiment.

FIG. 2 is a hydraulic circuit diagram illustrating a state in which an electronic brake system according to an embodiment performs a first braking mode.

FIG. 3 is a hydraulic circuit diagram illustrating a state in which an electronic brake system according to an embodiment performs a second braking mode.

FIG. 4 is a hydraulic circuit diagram illustrating a state in which an electronic brake system according to an embodiment performs a third braking mode.

FIG. 5 is a hydraulic circuit diagram illustrating a state in which an electronic brake system releases a third braking mode according to an embodiment.

FIG. 6 is a hydraulic circuit diagram illustrating a state in which an electronic brake system releases a second braking mode according to an embodiment.

FIG. 7 is a hydraulic circuit diagram illustrating a state in which an electronic brake system releases a first braking mode according to an embodiment.

FIG. 8 is a control block diagram illustrating an electronic brake system according to an embodiment.

FIGS. 9A and 9B are views illustrating a part of a hydraulic pressure supply device of an electronic brake system according to an embodiment.

FIG. 10 is an example of a stroke map used in an electronic brake system according to an embodiment.

FIG. 11 is a flowchart showing a method of controlling an electronic brake system according to an embodiment.

### MODES OF THE INVENTION

Hereinafter, an embodiment of the present disclosure will be described in detail with reference to the accompanying drawings. The following embodiment is provided to fully convey the spirit of the present disclosure to a person having ordinary skill in the art to which the present disclosure belongs. The present disclosure is not limited to the embodiment shown herein but may be embodied in other forms. The drawings are not intended to limit the scope of the present disclosure in any way, and the size of components may be exaggerated for clarity of illustration.

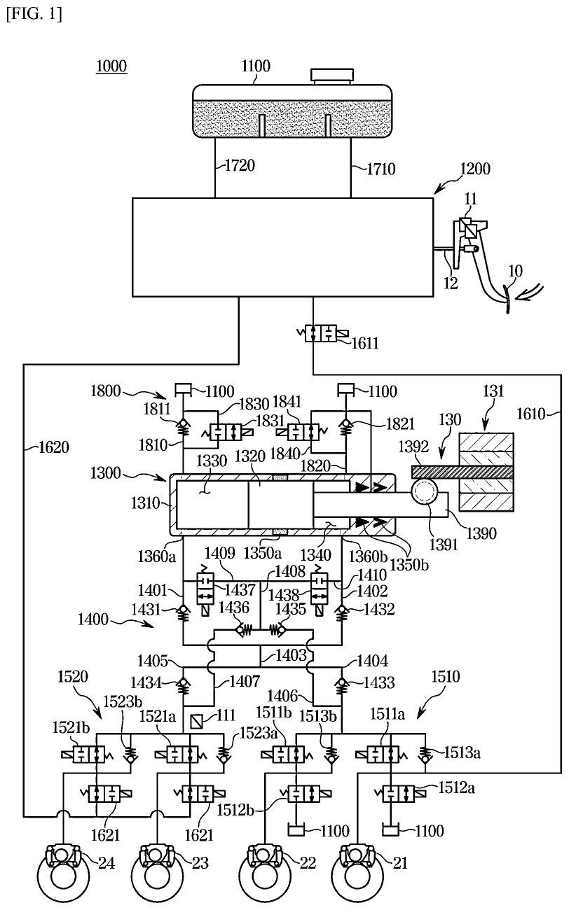

FIG. 1 is a hydraulic circuit diagram illustrating an electronic brake system according to an embodiment.

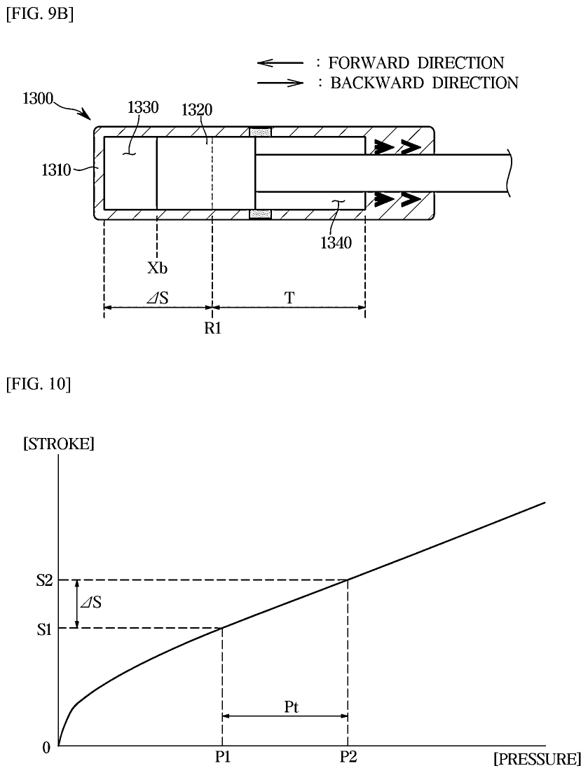

Referring to FIG. 1, an electronic brake system 1000 according to an embodiment of the present disclosure includes a reservoir 1100 in which a pressurized medium is stored, a master cylinder 1200 provided to provide a reaction force against a pedal effort of a brake pedal 10 to a driver and pressurize and discharge the pressurized medium, such as brake oil accommodated therein, a hydraulic pressure supply device 1300 provided to receive an electrical signal corresponding to a braking intention by a driver from a pedal displacement sensor 11 that detects a displacement of the brake pedal 10 and to generate a hydraulic pressure of the pressurized medium through a mechanical operation, a hydraulic control unit 1400 provided to control the hydraulic pressure provided from the hydraulic pressure supply device 1300, hydraulic circuits 1510 and 1520 having wheel cylinders 20 for braking respective wheels RR, RL, FR, and FL as the hydraulic pressure of the pressurized medium is transferred, a dump controller 1800 provided between the hydraulic pressure supply device 1300 and the reservoir 1100 to control a flow of the pressurized medium, backup flow paths 1610 and 1620 provided to hydraulically connect the integrated master cylinder 1200 and the hydraulic circuits 1510 and 1520, a reservoir flow path 1700 provided to hydraulically connect the reservoir 1100 and the integrated master cylinder 1200, and a controller (120 in FIG. 9) provided to control the hydraulic pressure supply device 1300 and various valves based on hydraulic pressure information and pedal displacement information.

The master cylinder 1200 is configured to, when the driver applies a pedal effort to the brake pedal 10 for braking operation, provide the driver with a reaction force against the pedal effort to provide a stable pedal feel, and at the same time pressurize and discharge the pressurized medium accommodated therein

The master cylinder 1200 may include at least one piston (not shown), and according to forward, backward or reciprocating movement of the at least one piston (not shown), generate a hydraulic pressure in a pressurized medium accommodated in each chamber or generate a negative pressure.

A pressurized medium may be introduced into and discharged from the master cylinder 1200 through various flow paths.

The master cylinder 1200 may be connected to two wheels of the wheels (RR, RL, FR, and FL) of the vehicle through a first backup flow path 1610, and may be connected to the other two vehicle wheels through a second backup flow path 1620.

In addition, the master cylinder 1200 may be connected to the reservoir 1100 through a first reservoir flow path 1710 and a second reservoir flow path 1720, and the pressurized medium may be discharged from the master cylinder 1200 to a side of the reservoir 1100, or may be introduced from the reservoir 1100 into the master cylinder 1200.

The reservoir 1100 may accommodate and store the pressurized medium therein. The reservoir 1100 may be connected to each component such as the master cylinder 1200, the hydraulic pressure supply device supply device 1300, which will be described below, and the hydraulic circuits, which will be described below, to supply or receive the pressurized medium. Although a plurality of the reservoirs 1100 is shown with the same reference numeral in the drawings, this is only an example for better understanding of the present disclosure, and the reservoir 1100 may be provided as a single component, or a plurality of the separate and independent reservoirs 1100 may be provided.

The hydraulic pressure supply device 1300 is provided to receive an electrical signal corresponding to a braking intention of the driver from the pedal displacement sensor 11 detecting a displacement of the brake pedal 10 and to generate a hydraulic pressure of the pressurized medium through a mechanical operation.

The hydraulic pressure supply device 1300 may include a hydraulic pressure providing unit to provide a pressure to the pressurized medium to be transferred to the wheel cylinders 20 a motor 131 to generate a rotational force by an electrical signal from the pedal displacement sensor 11, and a power conversion unit 130 to convert a rotational motion of the motor 131 into a linear motion to provide the linear motion to the hydraulic pressure providing unit.

The hydraulic pressure providing unit includes a cylinder block 1310 provided in which the pressurized medium may be accommodated, a hydraulic piston 1320 accommodated in the cylinder block 1310, a sealing member 1350 provided between the hydraulic piston 1320 and the cylinder block 1310 to seal pressure chambers 1330 and 1340, and a drive shaft 1390 to transfer power output from the power conversion unit 130 to the hydraulic piston 1320.

The pressure chambers 1330 and 1340 may include a first pressure chamber 1330 located in the front of the hydraulic piston 1320 (left direction of the hydraulic piston 1320 in FIG. 1), and a second pressure chamber 1340 located in the rear of the hydraulic piston 1320 (right direction of the hydraulic piston 1320 in FIG. 1). That is, the first pressure chamber 1330 is provided to be partitioned by the cylinder block 1310 and a front surface of the hydraulic piston 1320 so that a volume thereof varies depending on the movement of the hydraulic piston 1320, and the second pressure chamber 1340 is provided to be partitioned by the cylinder block 1310 and a rear surface of the hydraulic piston 1320 so that a volume thereof varies depending on the movement of the hydraulic piston 1320.

The first pressure chamber 1330 is connected to a first hydraulic flow path 1401, which will be described later, through a first communication hole 1360a formed on the cylinder block 1310, and the second pressure chamber 1340 is connected to a fourth hydraulic flow path 1404, which will be described below, through a second communication hole 1360b formed on the cylinder block 1310.

The sealing members include a piston sealing member 1350a provided between the hydraulic piston 1320 and the cylinder block 1310 to seal between the first pressure chamber 1330 and the second pressure chamber 1340, and a drive shaft sealing member 1350b provided between the drive shaft 1390 and the cylinder block 1310 to seal between the second pressure chamber 1340 and an opening of the cylinder block 1310. The hydraulic pressure or negative pressure of the first pressure chamber 1330 and the second pressure chamber 1340 generated by the forward or backward movement of the hydraulic piston 1320 may not leak by being sealed by the piston sealing member 1350a and the drive shaft sealing member 1350b and may be transferred to the first hydraulic flow path 1401 and the fourth hydraulic flow path 1404, which will be described later.

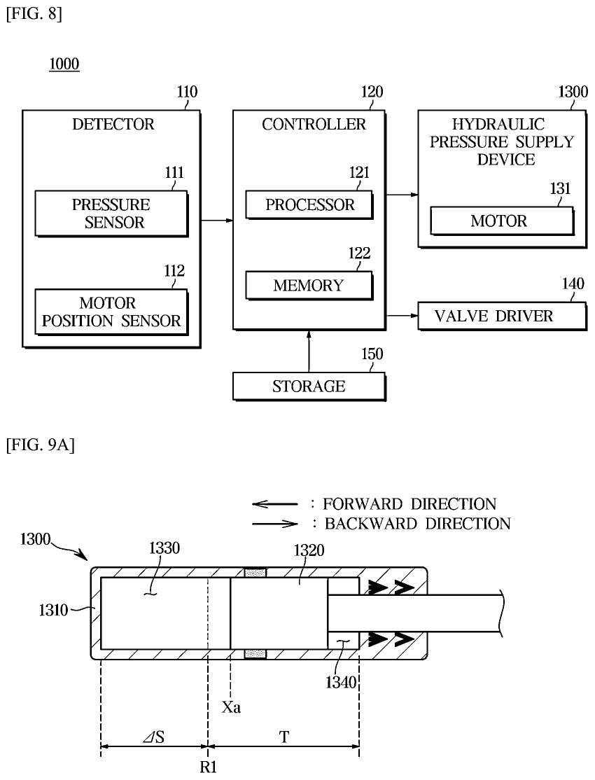

The motor (not shown) is provided to generate a driving force of the hydraulic piston 1320 by an electric signal output from the controller (120 in FIG. 8). The motor may include a stator and a rotor, and through this configuration, may provide power to generate a displacement of the hydraulic piston 1320 by rotating in a forward or reverse direction. A rotational angular speed and a rotational angle of the motor may be precisely controlled by a motor control sensor. Because the motor is a well-known technology, a detailed description thereof will be omitted.

The power conversion unit 130 is provided to convert a rotational force of the motor 131 into a linear motion. The power conversion unit 130 may be provided as a structure including, for example, a worm shaft 1392, a worm wheel 1391, and the drive shaft 1390.

The worm shaft 1392 may be integrally formed with a rotation shaft of the motor 131 and may rotate the worm wheel 1391 by a worm formed on an outer circumferential surface thereof to be engaged with the worm wheel 1391. The worm wheel 1391 may linearly move the drive shaft 1390 by being connected to be engaged with the drive shaft 1390, and the drive shaft 1390 is connected to the hydraulic piston 1320 so that the hydraulic piston 1320 may be slidably moved within the cylinder block 1310.

Explaining the above operations again, when the displacement of the brake pedal 10 is detected by the pedal displacement sensor 11, the detected signal is transferred to the controller (120 in FIG. 8), and the controller (120 in FIG. 8) drives the motor 131 to rotate the worm shaft 1392 in one direction. The rotational force of the worm shaft 1392 is transferred to the drive shaft 1390 via the worm wheel 1391, and the hydraulic piston 1320 connected to the drive shaft 1390 moves forward in the cylinder block 1310, thereby generating a hydraulic pressure in the first pressure chamber 1330.

Conversely, when the pressing force of the brake pedal 10 is released, the controller (120 in FIG. 8) drives the motor 131 to rotate the worm shaft 1392 in the opposite direction. Accordingly, the worm wheel 1391 also rotates in the opposite direction, and the hydraulic piston 1320 connected to the drive shaft 1390 moves backward in the cylinder block 1310, thereby generating a negative pressure in the first pressure chamber 1330.

The generation of a hydraulic pressure and negative pressure in the second pressure chamber 1340 may be implemented by operating opposite to the above operations. That is, when the displacement of the brake pedal 10 is detected by the pedal displacement sensor 11, the detected signal is transferred to the controller (120 in FIG. 8), and the controller (120 in FIG. 8) drives the motor 131 to rotate the worm shaft 1392 in the opposite direction. The rotational force of the worm shaft 1392 is transferred to the drive shaft 1390 via the worm wheel 1391, and the hydraulic piston 1320 connected to the drive shaft 1390 moves backward within the cylinder block 1310, thereby generating a hydraulic pressure in the second pressure chamber 1340.

Conversely, when the pressing force of the brake pedal 10 is released, the controller (120 in FIG. 8) drives the motor 131 to rotate the worm shaft 1392 in one direction. Accordingly, the worm wheel 1391 also rotates in one direction, and the hydraulic piston 1320 connected to the drive shaft 1390 moves forward in the cylinder block 1310, thereby generating a negative pressure in the second pressure chamber 1340.

As such, the hydraulic pressure supply device 1300 may generate a hydraulic pressure or negative pressure in each of the first pressure chamber 1330 and the second pressure chamber 1340 depending on the rotation direction of the worm shaft 1392 by the operation of the motor 131, and whether a hydraulic pressure is transferred to the chambers to perform braking, or whether a negative pressure is generated in the chambers to release braking may be determined by controlling the valves. A detailed description thereof will be described later.

A first dump check valve 1811 and a first dump valve 1831 for controlling the flow of the pressurized medium may be provided in the first dump flow path 1810 and the first bypass flow path 1830, respectively. The first dump check valve 1811 may be provided to allow only the flow of the pressurized medium from the reservoir 1100 toward the first pressure chamber 1330 and block the flow of the pressurized medium in the opposite direction. The first bypass flow path 1830 is connected in parallel with respect to the first dump check valve 1811 in the first dump flow path 1810, and the first dump valve 1831 for controlling the flow of the pressurized medium between the first pressure chamber 1330 and the reservoir 1100 may be provided in the first bypass flow path 1830. In other words, the first bypass flow path 1830 may bypass the first dump check valve 1811 on the first dump flow path 1810 to connect a front end and a rear end of the first dump check valve 1811, and the first dump valve 1831 may be provided as a bidirectional solenoid valve for controlling the flow of the pressurized medium between the first pressure chamber 1330 and the reservoir 1100. The first dump valve 1831 may be provided as a normally closed type solenoid valve that operates to be opened when an electric signal is received from the controller (120 in FIG. 8) in a normally closed state.

A second dump check valve 1821 and a second dump valve 1841 for controlling the flow of the pressurized medium may be provided in the second dump flow path 1820 and the second bypass flow path 1840, respectively. The second dump check valve 1821 may be provided to allow only the flow of the pressurized medium from the reservoir 1100 toward the second pressure chamber 1330 and block the flow of the pressurized medium in the opposite direction. The second bypass flow path 1840 is connected in parallel with respect to the second dump check valve 1821 in the second dump flow path 1820, and the second dump valve 1841 for controlling the flow of the pressurized medium between the second pressure chamber 1330 and the reservoir 1100 may be provided in the second bypass flow path 1840. In other words, the second bypass flow path 1840 may bypass the second dump check valve 1821 on the second dump flow path 1820 to connect a front end and a rear end of the second dump check valve 1821, and the second dump valve 1841 may be provided as a bidirectional solenoid valve for controlling the flow of the pressurized medium between the second pressure chamber 1330 and the reservoir 1100. The second dump valve 1841 may be provided as a normally open type solenoid valve that operates to be closed when an electric signal is received from the controller (120 in FIG. 8) in a normally open state.

The hydraulic control unit 1400 may be provided to control a hydraulic pressure transferred to the respective wheel cylinders 20, and the controller (120 in FIG. 8) is provided to control the hydraulic pressure supply device 1300 and various valves based on the hydraulic pressure information and pedal displacement information.

The hydraulic control unit 1400 may include a first hydraulic circuit 1510 for controlling the flow of the hydraulic pressure to be transferred to first and second wheel cylinders 21 and 22 among the four wheel cylinders, and a second hydraulic circuit 1520 for controlling the flow of the hydraulic pressure to be transferred to third and fourth wheel cylinders 23 and 24, and includes a plurality of flow paths and valves to control the hydraulic pressure to be transferred from the hydraulic pressure supply device 1300 to the wheel cylinders 20.

The first hydraulic flow path 1401 is provided to be in communication with the first pressure chamber 1330, and the second hydraulic flow path 1402 is provided in communication with the second pressure chamber 1340. The first hydraulic flow path 1401 joins the second hydraulic flow path 1402 at a third hydraulic flow path 1403 and then branches into a fourth hydraulic flow path 1404 connected to the first hydraulic circuit 1510 and a fifth hydraulic flow path 1405 connected to the second hydraulic circuit 1520.

A sixth hydraulic flow path 1406 is provided to be in communication with the first hydraulic circuit 1510, and a seventh hydraulic flow path 1407 is provided to be in communication with the second hydraulic circuit 1520. The sixth and seventh hydraulic flow paths 1406 and 1407 join at an eighth hydraulic flow path 1408, and then branch into a ninth hydraulic flow path 1409 communicating with the first pressure chamber 1409 and a tenth hydraulic flow path 1410 communicating with the second pressure chamber 1410.

The first hydraulic flow path 1401 may be provided with a first valve 1431 for controlling the flow of the pressurized medium. The first valve 1431 may be provided as a check valve for allowing the flow of the pressurized medium discharged from the first pressure chamber 1330 while blocking the flow of the pressurized medium in the opposite direction. Also, the second hydraulic flow path 1402 may be provided with a second valve 1432 for controlling the flow of the pressurized medium, and the second valve 1432 may be provided as a check valve for allowing the flow of the pressurized medium discharged from the second pressure chamber 1340 while blocking the flow of the pressurized medium in the opposite direction.

The fourth hydraulic flow path 1404 may branch again from the third hydraulic flow path 1403, at which the first hydraulic flow path 1410 and the second hydraulic flow path 1402 join, to be connected to the first hydraulic circuit 1510. The fourth hydraulic flow path 1404 may be provided with a third valve 1433 for controlling the flow of the pressurized medium, and the third valve 1433 may be provided as a check valve for allowing the flow of the pressurized medium from the third hydraulic flow path 1403 toward the first hydraulic circuit 1510 while blocking the flow of the pressurized medium in the opposite direction.

The fifth hydraulic flow path 1405 may branch again from the third hydraulic flow path 1403, at which the first hydraulic flow path 1410 and the second hydraulic flow path 1402 join, to be connected to the second hydraulic circuit 1520. The fifth hydraulic flow path 1405 may be provided with a fourth valve 1434 for controlling the flow of the pressurized medium, and the fourth valve 1434 may be provided as a check valve for allowing the flow of the pressurized medium from the third hydraulic flow path 1403 toward the second hydraulic circuit 1520 while blocking the flow of the pressurized medium in the opposite direction.

The sixth hydraulic flow path 1406 communicates with the first hydraulic circuit 1510, the seventh hydraulic flow path 1407 communicates with the second hydraulic circuit 1520, and the sixth hydraulic flow path 1406 and the seventh hydraulic flow path 1407 are provided to join at the eighth hydraulic flow path 1408. The sixth hydraulic flow path 1406 may be provided with a fifth valve 1435 for controlling the flow of the pressurized medium, and the fifth valve 1435 may be provided as a check valve for allowing the flow of the pressurized medium discharged from the first hydraulic circuit 1510 while blocking the flow of the pressurized medium in the opposite direction. In addition, the seventh hydraulic flow path 1407 may be provided with a sixth valve 1436 for controlling the flow of the pressurized medium, and the sixth valve 1436 may be provided as a check valve for allowing the flow of the pressurized medium discharged from the second hydraulic circuit 1520 while blocking the flow of the pressurized medium in the opposite direction.

The ninth hydraulic flow path 1409 may be provided to branch from the eighth hydraulic flow path 1408, at which the sixth hydraulic flow path 1406 and the seventh hydraulic flow path 1407 join, and connect to the first pressure chamber 1330. The ninth hydraulic flow path 1409 may be provided with a seventh valve 1437 for controlling the flow of the pressurized medium. The seventh valve 1437 may be provided as a bidirectional control valve for controlling the flow of the pressurized medium transferred along the ninth hydraulic flow path 1409. The seventh valve 1437 may be provided as a normally closed type solenoid valve that operates to be opened when an electric signal is received from the controller (120 in FIG. 8) in a normally closed state.

The tenth hydraulic flow path 1410 may be provided to branch from the eighth hydraulic flow path 1408, at which the sixth hydraulic flow path 1406 and the seventh hydraulic flow path 1407 join, and connect to the second pressure chamber 1340. The tenth hydraulic flow path 1410 may be provided with an eighth valve 1438 for controlling the flow of the pressurized medium. The eighth valve 1438 may be provided as a bidirectional control valve for controlling the flow of the pressurized medium transferred along the tenth hydraulic flow path 1410. The eighth valve 1438 may be provided as a normally closed type solenoid valve that operates to be opened when an electric signal is received from the controller (120 in FIG. 8) in a normally closed state, similar to the seventh valve 1437.

By the arrangement of the hydraulic flow paths and valves of the hydraulic control unit 1400 as described above, the hydraulic pressure generated in the first pressure chamber 1330 according to the forward movement of the hydraulic piston 1320 may be transferred to the first hydraulic circuit 1510 by sequentially passing through the first hydraulic flow path 1401, the third hydraulic flow path 1403, and the fourth hydraulic flow path 1404, and may be transferred to the second hydraulic circuit 1520 by sequentially passing through the first hydraulic flow path 1401, the third hydraulic flow path 1403, and the fifth hydraulic flow path 1405. Also, the hydraulic pressure formed in the second pressure chamber 1340 according to the backward movement of the hydraulic piston 1320 may be transferred to the first hydraulic circuit 1510 by sequentially passing through the second hydraulic flow path 1402, the third hydraulic flow path 1403, and the fourth hydraulic flow path 1404, and may be transferred to the second hydraulic circuit 1520 by sequentially passing through the second hydraulic flow path 1402, the third hydraulic flow path 1403, and the fifth hydraulic flow path 1405.

Conversely, the negative pressure generated in the first pressure chamber 1330 according to the backward movement of the hydraulic piston 1320 may recover the pressurized medium provided in the first hydraulic circuit 1510 to the first pressure chamber 1330 by sequentially passing through the sixth hydraulic flow path 1406, the eighth hydraulic flow path 1408, and the ninth hydraulic flow path 1409, and may recover the pressurized medium provided in the second hydraulic circuit 1520 to the first pressure chamber 1330 by sequentially passing through the seventh hydraulic flow path 1407, the eighth hydraulic flow path 1408, and the ninth hydraulic flow path 1409. In addition, the negative pressure generated in the second pressure chamber 1340 according to the forward movement of the hydraulic piston 1320 may recover the pressurized medium provided in the first hydraulic circuit 1510 to the first pressure chamber 1330 by sequentially passing through the sixth hydraulic flow path 1406, the eight hydraulic flow path 1408, and the tenth hydraulic flow path 1410, and may recover the pressurized medium provided in the second hydraulic circuit 1520 to the second pressure chamber 1340 by sequentially passing through the seventh hydraulic flow path 1407, the eighth hydraulic flow path 1408, and the tenth hydraulic flow path 14010,

In addition, the negative pressure generated in the first pressure chamber 1330 according to the backward movement of the hydraulic piston 1320 may supply the pressurized medium from the reservoir 1100 to the first pressure chamber 1330 through the first dump flow path 1810. The negative pressure generated in the second pressure chamber 1340 according to the forward movement of the hydraulic piston 1320 may supply the pressurized medium from the reservoir 1100 to the second pressure chamber 1340 through the second dump flow path 1820.

A detailed description of the transfer of the hydraulic pressure and negative pressure by the arrangement of these hydraulic flow paths and valves will be described below.

The first hydraulic circuit 1510 of the hydraulic control unit 1400 may control the hydraulic pressure in the first wheel cylinder 21 and the second wheel cylinder 22, which are two-wheel cylinders 20 among the four wheels RR, RL, FR, and FL, and the second hydraulic circuit 1520 may control the hydraulic pressure in the third and fourth wheel cylinders 23 and 24 which are the other two wheel cylinders 20.

The first hydraulic circuit 1510 may receive the hydraulic pressure through the fourth hydraulic flow path 1404 and discharge the hydraulic pressure through the sixth hydraulic flow path 1406. To this end, as illustrated in FIG. 1, the fourth hydraulic flow path 1404 and the sixth hydraulic flow path 1406 may be provided to be branched into two flow paths, which are connected to the first wheel cylinder 21 and the second wheel cylinder 22, after joining. Also, the second hydraulic circuit 1520 may receive the hydraulic pressure through the fifth hydraulic flow path 1405 and discharge the hydraulic pressure through the seventh hydraulic flow path 1407, and accordingly, as illustrated in FIG. 1, the fifth hydraulic flow path 1405 and the seventh hydraulic flow path 1407 may be provided to be branched into two flow paths, which are connected to the third wheel cylinder 23 and the fourth wheel cylinder 24, after joining. However, the connection of the hydraulic flow paths illustrated in FIG. 1, which is an example for helping the understanding of the present disclosure, is not limited thereto, and may be provided in various manners and structures as such as cases in which the fourth hydraulic flow path 1404 and the sixth hydraulic flow path 1406 may be connected to the first hydraulic circuit 1510 side, respectively, and independently branched to be connected to the first wheel cylinder 21 and the second wheel cylinder 22, and likewise, the fifth hydraulic flow path 1405 and the seventh hydraulic flow path 1407 may be connected to the second hydraulic circuit 1520 side, respectively, and independently branched to be connected to the third wheel cylinder 23 and the fourth wheel cylinder 24.

The first and second hydraulic circuits 1510 and 1520 may include first to fourth inlet valves 1511a, 1511b, 1521a, and 1521b, respectively, to control the flow and hydraulic pressure of the pressurized medium to be transferred to the first to fourth wheel cylinders 21 to 24. The first to fourth inlet valves 1511a, 1511b, 1521a, and 1521b are disposed on upstream sides of the first to fourth wheel cylinders 20, respectively, and may be provided as a normally open type solenoid valve that operates to be closed when an electric signal is received from the electronic control unit in a normally open state.

The first and second hydraulic circuits 1510 and 1520 may include first to fourth check valves 1513a, 1513b, 1523a, and 1523b provided to be connected in parallel with respect to the first to fourth inlet valves 1511a, 1511b, 1521a, and 1521b. The check valves 1513a, 1513b, 1523a, and 1523b may be provided in the bypass flow paths that connect front sides and rear sides of the first to fourth inlet valves 1511a, 1511b, 1521a, and 1521b on the first and second hydraulic circuits 1510 and 1520, and may allow only the flow of pressurized medium from each of the wheel cylinders 20 to the hydraulic pressure supply device 1300 while blocking the flow of the pressurized medium from the hydraulic pressure supply device 1300 to the wheel cylinders 20. By the first to fourth check valves 1513a, 1513b, 1523a, and 1523b, the hydraulic pressure of the pressurized medium applied to each of the wheel cylinders 20 may be quickly released, and even when the first to fourth inlet valves 1511a, 1511b, 1521a, and 1521b do not operate normally, the hydraulic pressure of the pressurized medium applied to the wheel cylinders 20 may be smoothly returned to the hydraulic pressure providing unit.

The first hydraulic circuit 1510 may include first and second outlet valves 1512a and 1512b for controlling the flow of the pressurized medium discharged from the first and second wheel cylinders 21 and 22 to improve performance when braking of the first and second wheel cylinders 21 and 22 is released. The first and second outlet valves 1512a and 1512b are provided on discharge sides of the first and second wheel cylinders 21 and 22, respectively, to control the flow of the pressurized medium transferred from the first and second wheel cylinders 21 and 22 to the reservoir 1100. The first and second outlet valves 1512a and 1512b may be provided as normally closed type solenoid valves that operate to be opened when an electric signal is received from the electronic control unit in a normally closed state. In an ABS braking mode of the vehicle, the first and second outlet valves 1512a and 1512b may selectively release the hydraulic pressure of the pressurized medium applied to the first and second wheel cylinders 21 and 22 and transfer the released hydraulic pressure of the pressurized medium to the reservoir 1100 side.

The second backup flow path 1620, which will be described below, may be branched and connected to the third and fourth wheel cylinders 23 and 24 of the second hydraulic circuit 1520, and the at least one second cut valve 1621 may be provided in the second backup flow path 1620 to control the flow of the pressurized medium between the third and fourth wheel cylinders 23 and 24 and the master cylinder 1200.

The first backup flow path 1610 is provided to connect the master cylinder 1200 and the first hydraulic circuit 1510, and the second backup flow path 1620 is provided to connect the master cylinder 1200 and the second hydraulic circuit 1520.

The first backup flow path 1610 may be provided with a first cut valve 1611 for controlling the bidirectional flow of the pressurized medium, and the second backup flow path 1620 may be provided with at least one second cut valve 1621 for controlling the bidirectional flow of the pressurized medium. The first cut valve 1611 and the second cut valve 1621 may be provided as a normally open type solenoid valve that operates to be closed when a closing signal is received from the controller (120 in FIG. 8) in a normally open state.

The second cut valve 1621 may be provided as a pair of second cut valves 1621 on the third wheel cylinder 23 and the fourth wheel cylinder 24, respectively, as shown in FIG. 1, and in an ABS braking mode of the vehicle, may selectively release the hydraulic pressure of the pressurized medium applied to the third wheel cylinder 23 and the fourth wheel cylinder 24 and discharge the released hydraulic pressure of the pressurized medium to the reservoir 1100 side by sequentially passing through the second backup flow path 1620, the master cylinder 1200, and the second reservoir flow path.

The electronic brake system 1000 according to the present embodiment may include a pressure sensor 111 to detect a hydraulic pressure in at least one of the first hydraulic circuit 1510 and the second hydraulic circuit 1520. The drawing illustrates that the pressure sensor 111 is provided in the second hydraulic circuit 1520 side, but the pressure sensor is not limited to the above position and number, and as long as the hydraulic pressures in the hydraulic circuits 1510 and 1520, the master cylinder 1200, and the hydraulic pressure supply device 1300 may be detected, the pressure sensor may be provided in various positions and in various numbers.

Hereinafter, operation modes of the electronic brake system 1000 according to the embodiment of the present disclosure will be described.

The operation mode of the electronic brake system 1000 according to the present embodiment may be divided into first to third braking modes as the hydraulic pressure transferred from the hydraulic pressure supply device 1300 to the wheel cylinders 20 increases.

Specifically, in the first braking mode, the hydraulic pressure by the hydraulic pressure supply device 1300 may be primarily provided to the wheel cylinders 20, in the second braking mode, the hydraulic pressure by the hydraulic pressure supply device 1300 may be secondarily provided to the wheel cylinders 20 to transfer a higher braking pressure than in the first braking mode, and in the third braking mode, the hydraulic pressure by the hydraulic pressure supply device 1300 may be thirdly provided to the wheel cylinders 20 to transfer a higher braking pressure than in the second braking mode.

The first to third braking modes may be changed by changing the operations of the hydraulic pressure supply device 1300 and the hydraulic pressure control unit 1400. The hydraulic pressure supply device 1300 may provide a sufficiently high hydraulic pressure of the pressurized medium without a high specification motor by utilizing the first to third braking modes, and furthermore, may prevent unnecessary loads applied to the motor. Therefore, a stable braking force may be secured while reducing the cost and weight of the brake system, and durability and operational reliability of the devices may be improved.

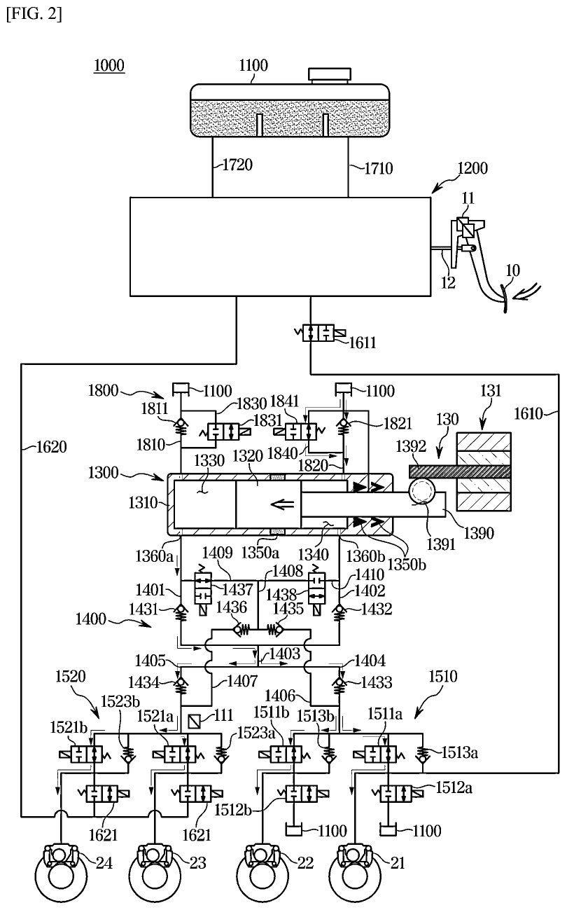

FIG. 2 is a hydraulic circuit diagram illustrating a state in which an electronic brake system according to an embodiment performs a first braking mode.

Referring to FIG. 2, when the driver depresses the brake pedal 10 at the beginning of braking, the motor (not shown) operates to rotate in one direction, the rotational force of the motor 131 is transferred to the hydraulic pressure providing unit by the power conversion unit 130, and the hydraulic piston 1320 of the hydraulic pressure providing unit moves forward, thereby generating a hydraulic pressure in the first pressure chamber 1330. The hydraulic pressure discharged from the first pressure chamber 1330 is transferred to the respective wheel cylinders 20 through the hydraulic control unit 1400, the first hydraulic circuit 1510 and the second hydraulic circuit 1520, thereby generating a braking force.

Specifically, a part of the hydraulic pressure generated in the first pressure chamber 1330 is primarily transferred to the first wheel cylinder 21 and the second wheel cylinder 22 provided in the first hydraulic circuit 1510 by sequentially passing through the first hydraulic flow path 1401, the third hydraulic flow path 1403, and the fourth hydraulic flow path 1404. At this time, as the first valve 1431 is provided as a check valve for allowing only the flow of the pressurized medium discharged from the first pressure chamber 1330, and the third valve 1433 is provided as a check valve for allowing only the flow of the pressurized medium from the third hydraulic flow path 1403 toward the first hydraulic circuit 1510, the hydraulic pressure of the pressurized medium may be smoothly transferred to the first and second wheel cylinders 21 and 22. Also, the first inlet valve 1511a and the second inlet valve 1511b provided in the first hydraulic circuit 1510 are maintained in an open state, and the first outlet valve 1512a and the second outlet valve 1512b are maintained in a closed state, thereby preventing the hydraulic pressure of the pressurized medium from leaking into the reservoir 1100 side.

In addition, the hydraulic pressure generated in the first pressure chamber 1330 is primarily transferred to the third and fourth wheel cylinders 23 and 24 provided in the second hydraulic circuit 1520 by sequentially passing through the first hydraulic flow path 1401, the third hydraulic flow path 1403, and the fifth hydraulic flow path 1405. As described above, as the first valve 1431 is provided as a check valve for allowing only the flow of the pressurized medium discharged from the first pressure chamber 1330, and the fourth valve 1434 is provided as a check valve for allowing only the flow of the pressured medium toward from the third hydraulic flow path 1403 toward the second hydraulic circuit 1520 side, the hydraulic pressure of the pressurized medium may be smoothly transferred to the third and fourth wheel cylinders 23 and 24. Also, the third inlet valve 1521a and the fourth inlet valve 1521b provided in the second hydraulic circuit 1520 are maintained in an open state, and a second cut valve 1622 is maintained in a closed state, thereby preventing the hydraulic pressure of the pressurized medium from leaking into the second backup flow path 1620 side.

In the first braking mode, the eighth valve 1438 is controlled in a closed state, the hydraulic pressure of the pressurized medium generated in the first pressure chamber 1330 may be prevented from leaking into the second pressure chamber 1340. In addition, the first dump valve 1831 provided in the first bypass flow path 1830 is maintained in a closed state, thereby preventing the hydraulic pressure formed in the first pressure chamber 1330 from leaking into the reservoir 1100.

On the other hand, as the hydraulic piston 1320 moves forward, negative pressure is generated in the second pressure chamber 1340, and the hydraulic pressure of the pressurized medium is transferred from the reservoir 1100 to the second pressure chamber 1340 through the second dump flow path 1820 to prepare the second braking mode to be described below. Since the second dump check valve 1821 provided in the second dump flow path 1820 allows the flow of the pressurized medium from the reservoir 1100 to the second pressure chamber 1340, the pressurized medium may be stably supplied to the second pressure chamber 1340, and the first dump valve 1841 provided in the second bypass flow path 1840 may be switched to an open state to rapidly supply the pressurized medium from the reservoir 1100 to the first pressure chamber 1330.

In the first braking mode in which braking of the wheel cylinders 20 is performed by the hydraulic pressure supply device 1300, the first cut valve 1611 and the second cut valve 1611 provided in the first backup flow path 1610 and the second backup flow path 1620, respectively, are switched to be closed, so that the pressurized medium discharged from the integrated master cylinder 1200 is prevented from being transferred to the wheel cylinders 20 side.

Specifically, when a pedal effort is applied to the brake pedal 10, the first cut valve 1611 is closed to cause the master chamber 1220a to be sealed. As a pedal effort tis applied to the brake pedal 10, the pressurized medium accommodated in the master chamber 1220a is pressurized to generate a hydraulic pressure, the hydraulic pressure of the pressurized medium generated in the master chamber 1220a is transferred to the front surface (right side of FIG. 2) of the first simulation piston 1230, and because the simulator valve 1261 is opened in the normal operation mode, a displacement may occur in the first simulation piston 1230. On the other hand, because an inspection valve 1631 is closed in the normal operation mode of the electronic brake system 1000, the second simulation chamber 1240a is sealed so that no displacement occurs in the second simulation piston 1240, Accordingly, the displacement of the first simulation piston 1230 causes the elastic member 1250 to be compressed, and an elastic restoring force by the compression of the elastic member 1240 is provided to the driver as a pedal feeling. In this case, the pressurized medium accommodated in the first simulation chamber 1230a is discharged to the reservoir 1100 through the simulation flow path 1260.

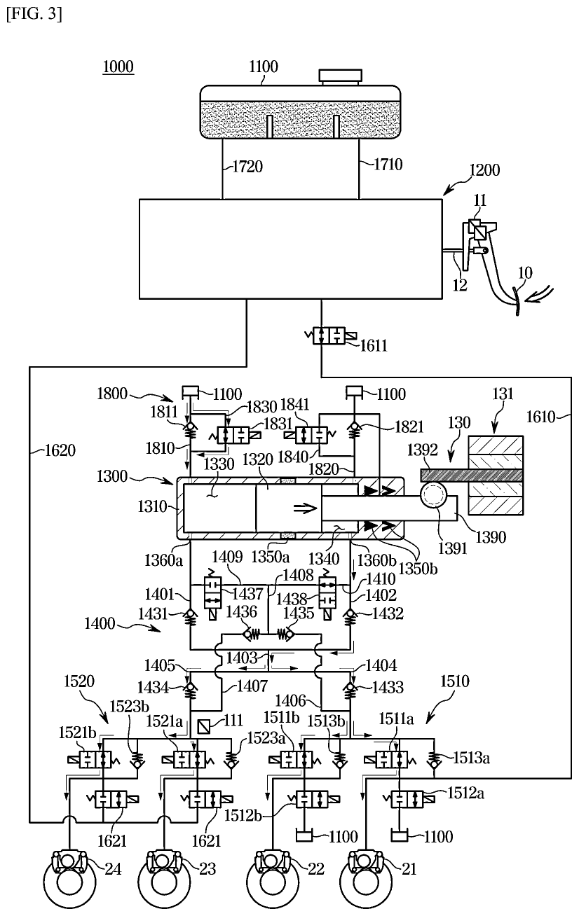

The electronic brake system 1000 according to the present embodiment may switch from the first braking mode to the second braking mode shown in FIG. 3 when there is a need to provide a braking pressure higher than that in the first braking mode.

FIG. 3 is a hydraulic circuit diagram illustrating a state in which an electronic brake system according to an embodiment performs a second braking mode.

Referring to FIG. 3, when a displacement or an operating speed of the brake pedal 10 detected by the pedal displacement sensor 11 is higher than a preset level or a hydraulic pressure detected by the pressure sensor is higher than a preset level, the controller (120 in FIG. 8) may determine that a higher braking pressure is required, and switch from the first braking mode to the second braking mode.

When the first braking mode is switched to the second braking mode, the motor operates to rotate in the other direction, and the rotational force of the motor 131 is transferred to the hydraulic pressure providing unit by the power conversion unit 130 so that the hydraulic piston 1320 moves backward, thereby generating a hydraulic pressure in the second pressure chamber 1340. The hydraulic pressure discharged from the second pressure chamber 1340 is transferred to the respective wheel cylinders 20 through the hydraulic control unit 1400, the first hydraulic circuit 1510, and the second hydraulic circuit 1520, thereby generating a braking force.

Specifically, the hydraulic pressure generated in the second pressure chamber 1340 is secondarily transferred to the first wheel cylinder 21 and the second wheel cylinder 22 provided in the first hydraulic circuit 1510 by sequentially passing through the second hydraulic flow path 1402, the third hydraulic flow path 1403, and the fourth hydraulic flow path 1404. In this case, the second valve 1432 provided in the second hydraulic flow path 1402 is provided as a check valve for allowing only the flow of the pressurized medium from the second pressure chamber 1340, and the third valve 1433 provided in the fourth hydraulic flow path 1404 is provided as a check valve for allowing only the flow of the pressurized medium from the third hydraulic flow path 1403 toward the first hydraulic circuit 1510, the hydraulic pressure of the pressurized medium may be smoothly transferred to the first wheel cylinder 21 and the second wheel cylinder 22. The first inlet valve 1511a and the second inlet valve 1511b provided in the first hydraulic circuit 1510 are maintained in the open state, and the first outlet valve 1515a and the second outlet valve 1512b are maintained in the closed state, thereby preventing, suppressing, or reducing the hydraulic pressure of the pressurized medium from leaking into the reservoir 1100 side.

Also, the hydraulic pressure generated in the second pressure chamber 1340 is secondarily transferred to the third wheel cylinder 23 and the fourth wheel cylinder 24 provided in the second hydraulic circuit 1520 by sequentially passing through the second hydraulic flow path 1402, the third hydraulic flow path 1403, and the fifth hydraulic flow path 1405. As described above, since the second valve 1432 provided in the second hydraulic flow path 1403 is provided as a check valve for allowing only the flow of the pressurized medium discharged from the second pressure chamber 1340, and the fourth valve 1434 provided in the fifth hydraulic flow path 1405 is provided as a check valve for allowing only the flow of the pressurized medium from the third hydraulic flow path 1403 toward the second hydraulic circuit 1520, the hydraulic pressure of the pressurized medium may be smoothly transferred to the third wheel cylinder 23 and the fourth wheel cylinder 24. In addition, the third inlet valve 1521a and the fourth inlet valve 1521b provided in the second hydraulic circuit 1520 are maintained in the open state, and the second cut valve 1622 is maintained in the closed state, thereby preventing, suppressing or reducing the hydraulic pressure of the pressurized medium from leaking into the second backup flow path 1620 side.

In the second braking mode, since the seventh valve 1437 is controlled to be a closed state, the hydraulic pressure of the pressurized medium generated in the second pressure chamber 1340 may be prevented, suppressed or reduced from leaking into the first pressure chamber 1330. In addition, the second dump valve 1841 is switched to a closed state to prevent, suppress, or reduce the hydraulic pressure of the pressurized medium generated in the second pressure chamber 1340 from leaking into the reservoir 1100 side.

On the other hand, as the hydraulic piston 1320 moves backward, negative pressure is generated in the first pressure chamber 1330, the hydraulic pressure of the pressurized medium is transferred from the reservoir 1100 to the first pressure chamber 1330 through the first dump flow path 1810 to prepare the third braking mode to be described below. Since the first dump check valve 1811 provided in the first dump flow path 1810 allows the flow of the pressurized medium from the reservoir 1100 to the first pressure chamber 1330, the pressurized medium may be stably supplied to the first pressure chamber 1330, and the first dump valve 1831 provided in the first bypass flow path 1830 is switched to an open state to rapidly supply the pressurized medium from the reservoir 1100 to the first pressure chamber 1330.

Because an operation of the master cylinder 1200 in the second braking mode is same as the operation of the master cylinder 1200 of the electronic brake system in the first braking mode described above, in order to prevent redundant description, a description thereof will be omitted.

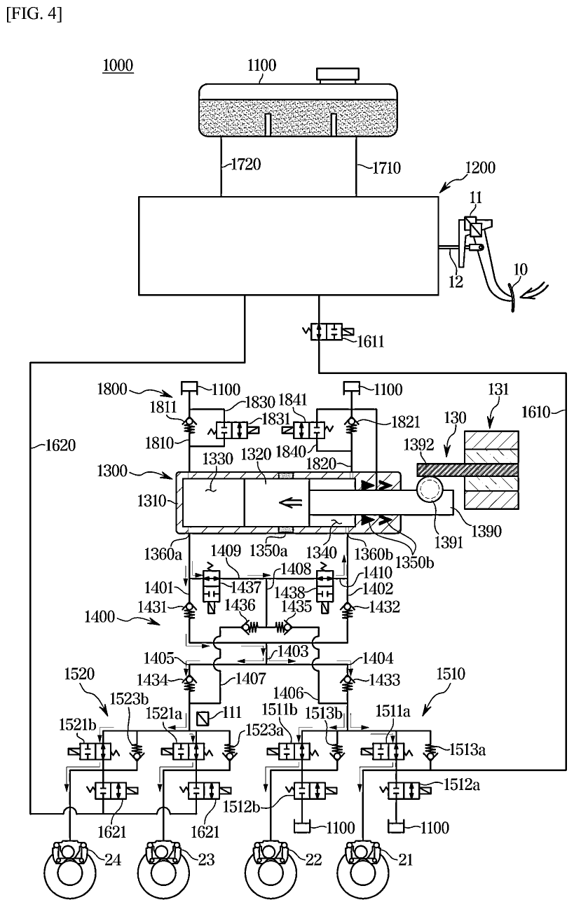

The electronic brake system 1000 according to the embodiment of the present disclosure may switch from the second braking mode to the third braking mode shown in FIG. 4 when there is a need to provide a braking pressure higher than that in the second braking mode.

FIG. 4 is a hydraulic circuit diagram illustrating a state in which an electronic brake system according to an embodiment performs a third braking mode.

Referring to FIG. 4, when a displacement or an operating speed of the brake pedal 10 detected by the pedal displacement sensor 11 is higher than the preset level or a hydraulic pressure detected by the pressure sensor is higher than the preset level, the controller (120 in FIG. 8) may determine that a higher braking pressure is required and switch from the second braking mode to the third braking mode.

When the second braking mode is switched to the third braking mode, the motor (not shown) operates to rotate in one direction, and the rotational force of the motor is transferred to the hydraulic pressure providing unit by the power conversion unit 130, and the hydraulic piston 1320 of the hydraulic pressure providing unit moves forward again, thereby generating a hydraulic pressure in the first pressure chamber 1330. The hydraulic pressure discharged from the first pressure chamber 1330 is transferred to the respective wheel cylinders 20 through the hydraulic control unit 3400, the first hydraulic circuit 1510, and the second hydraulic circuit 1520, thereby generating a braking force.

Specifically, a part of the hydraulic pressure generated in the first pressure chamber 1330 is primarily transferred to the first wheel cylinder 21 and the second wheel cylinder 22 provided in the first hydraulic circuit 1510 by sequentially passing through the first hydraulic flow path 1401, the third hydraulic flow path 1403, and the fourth hydraulic flow path 1404. In this case, as the first valve 1431 is provided as a check valve for allowing only the flow of the pressurized medium discharged from the first pressure chamber 1330, and the third valve 1433 is provided as a check valve for allowing only the flow of the pressurized medium from the third hydraulic flow path 1403 toward the first hydraulic circuit 1510, so that the hydraulic pressure of the pressurized medium may be smoothly transferred to the first and second wheel cylinders 21 and 22. In addition, the first inlet valve 1511a and the second inlet valve 1511b provided in the first hydraulic circuit 1510 are maintained in the open state, and the first outlet valve 1512a and the second outlet valve 1512b are maintained in the closed state, thereby preventing the hydraulic pressure of the pressurized medium from leaking into the reservoir 1100 side.

In addition, a part of the hydraulic pressure generated in the first pressure chamber 1330 is primarily transferred to the third wheel cylinder 23 and the fourth wheel cylinder 24 provided in the second hydraulic circuit 1520 by sequentially passing through the first hydraulic flow path 1401, the third hydraulic flow path 1403, and the fifth hydraulic flow path 1405. As described above, since the first valve 1431 is provided as a check valve for allowing only the flow of the pressurized medium discharged from the first pressure chamber 1330, and the fourth valve 1434 is provided as a check valve for allowing only the flow of the pressurized medium from the third hydraulic flow path 1403 toward the second hydraulic circuit 1520, so that the hydraulic pressure of the pressurized medium may be smoothly transferred to the third and fourth wheel cylinders 23 and 24. In addition, the third inlet valve 1521a and the fourth inlet valve 1521b provided in the second hydraulic circuit 1520 are maintained in the open state, and the second cut valve 1622 is maintained in the closed state, thereby preventing, suppressing, or reducing the hydraulic pressure of the pressurized medium from leaking into the second backup flow path 1620 side.

Meanwhile, because the third braking mode refers a state in which the pressurized medium of a high pressure is provided, as the hydraulic piston 1320 moves forward, a force of the hydraulic pressure in the first pressure chamber 1330 to move the hydraulic piston 1320 backward also increases, so that a load applied to the motor increases rapidly. Accordingly, in the third braking mode, the seventh valve 1437 and the eighth valve 1438 operate to be opened, thereby allowing the flow of the pressurized medium through the ninth hydraulic flow path 1409 and the tenth hydraulic flow path 1410. In other words, a part of the hydraulic pressure generated in the first pressure chamber 1330 may be supplied to the second pressure chamber 1340 by sequentially passing through the ninth hydraulic flow path 1409 and the tenth seventh hydraulic flow path 1410, and through this, the first pressure chamber 1330 and the second pressure chamber 1340 communicate with each other to synchronize the hydraulic pressure, so that the load applied to the motor may be reduced and the durability and reliability of the devices may be improved.

In the third braking mode, the first dump valve 1831 is switched to the closed state, so that the hydraulic pressure of the pressurized medium generated in the first pressure chamber 1330 may be prevented, suppressed, or reduced from leaking into the reservoir 1100 along the first bypass flow path 1830, and the second dump valve 2841 is also controlled to be closed so that a negative pressure may be rapidly generated in the second pressure chamber 1340 by the forward movement of the hydraulic piston 1320, and the pressurized medium provided from the first pressure chamber 1330 may be smoothly supplied to the second pressure chamber 1340.

That is, with the switching operation to the third braking mode, the hydraulic piston 1320 of the electronic brake system 1000 moves forward, increasing the hydraulic pressure of the pressurized medium applied to the hydraulic circuits 1510 and 1520

Because an operation of the integrated master cylinder 1200 in the third braking mode is same as the operation of the integrated master cylinder 1200 of the electronic brake system in the first and second braking modes described above, in order to prevent redundant description, a description thereof will be omitted.

Hereinafter, an operation method of the electronic brake system 1000 according to the present embodiment in which the braking is released from the normal operation mode will be described.

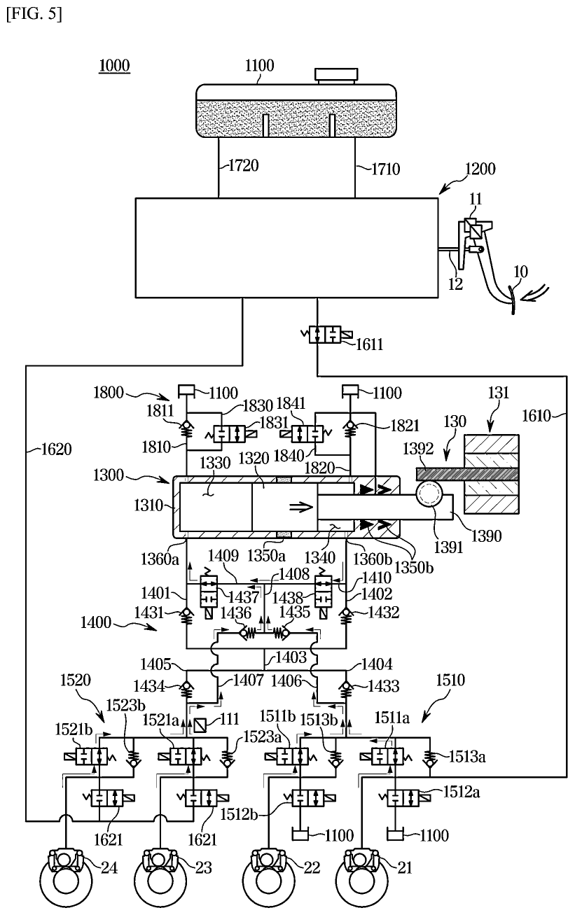

FIG. 5 is a hydraulic circuit diagram illustrating a state in which an electronic brake system disables a third braking mode according to an embodiment.

Referring to FIG. 5, the hydraulic piston 1320 of the electronic brake system 1000 may move backward, releasing the third braking mode.

When the pedal effort applied to the brake pedal 10 is released, the motor generates a rotational force in the other direction and transfers the rotational force to the power conversion unit 130, and the power conversion unit 130 moves the hydraulic piston 1320 backward. Accordingly, the hydraulic pressure in the first pressure chamber 1330 is released, and at the same time, a negative pressure may be generated, so that the pressurized medium in the wheel cylinders 20 may be transferred to the first pressure chamber 1330.

Specifically, the hydraulic pressure of the first wheel cylinder 21 and the second wheel cylinder 22 provided in the first hydraulic circuit 1510 is recovered to the first pressure chamber 1330 by sequentially passing through the sixth hydraulic flow path 1406, the eighth hydraulic flow path 1408, and the ninth hydraulic flow path 1409. In this case, the fifth valve 1435 provided in the sixth hydraulic flow path 1406 is provided as a check valve for allowing the flow of the pressurized medium discharged from the first hydraulic circuit 1510, so that the pressurized medium may be recovered. In addition, the seventh valve 14337 is opened to allow the flow of the pressurized medium through the ninth flow path 1409. In addition, the first dump valve 1831 operates to be closed such that negative pressure is effectively generated in the first pressure chamber 1330.

At the same time, to promote the rapid and smooth backward movement of the hydraulic piston 1320, the pressurized medium accommodated in the second pressure chamber 1340 is transferred to the first pressure chamber 1330 by sequentially passing through the tenth hydraulic flow path 1410 and the ninth hydraulic flow path 1409, and to this end, the eighth valve 1438 provided in the tenth hydraulic flow path 1410 is also switched to an open state. In this case, the second dump valve 1841 may operate to be closed to induce the pressurized medium of the second pressure chamber 1340 to be supplied to the first pressure chamber 1330. The first inlet valve 1511a and the second inlet valve 1511b provided in the first hydraulic circuit 1510 are maintained in an open state, and the first outlet valve 1512a and the second outlet valve 1512b are maintained in a closed state.

In addition, the hydraulic pressure of the pressurized medium applied to the third wheel cylinder 23 and the fourth wheel cylinder 24 provided in the second hydraulic circuit 1520 by the negative pressure generated in the first pressure chamber 1330 is recovered to the first pressure chamber 1330 by sequentially passing through the seventh hydraulic flow path 1407, the eight hydraulic flow path 1408, and the ninth hydraulic flow path 1409. As described above, since the sixth valve 1436 provided in the seventh hydraulic flow path 1407 is provided as a check valve for allowing only the flow of the pressurized medium discharged from the second hydraulic circuit 1520, the recovery of the pressurized medium may be performed, and the seventh valve 1437 is opened to allow the flow of the pressurized medium through the ninth hydraulic flow path 1409. In addition, the third inlet valve 1521a and the fourth inlet valve 1521b provided in the second hydraulic circuit 1520 are maintained in an open state.

That is, with the releasing operation in the third mode, the hydraulic piston 1320 of the electronic basic system 1320 moves backward, to reduce the hydraulic pressure of the pressurized medium applied to the hydraulic circuits 1510 and 1520.

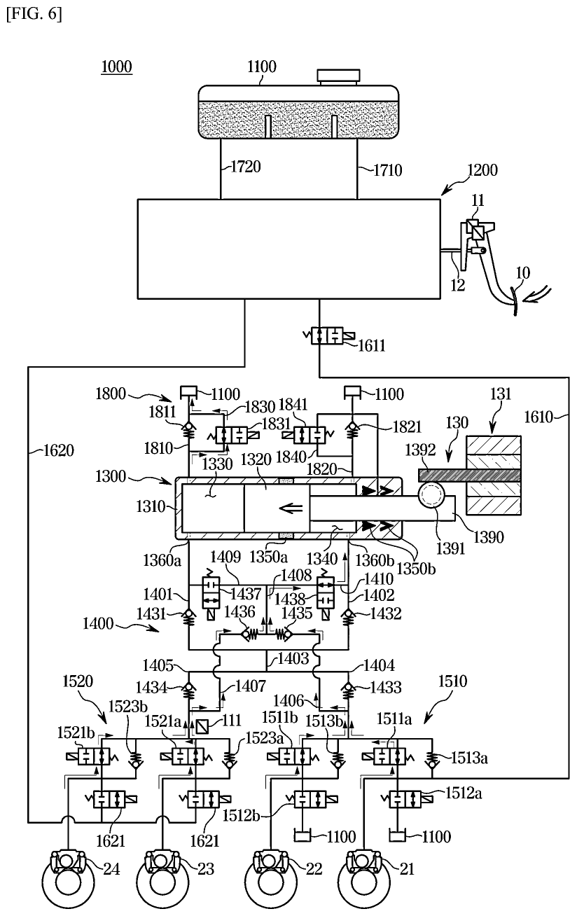

After the releasing of the third braking mode is completed, it may be switched to the releasing operation of the second braking mode illustrated in FIG. 6 in order to further lower the braking pressure applied to the wheel cylinders.

FIG. 6 is a hydraulic circuit diagram illustrating a state in which an electronic brake system disables a second braking mode according to an embodiment.

Referring to FIG. 6, the hydraulic piston 1320 of the electronic brake system 1000 may move forward, releasing the second braking mode.

When the pedal effort applied to the brake pedal 10 is released, the motor generates a rotational force in one direction and transfers the rotational force to the power conversion unit 130, and the power conversion unit 130 moves the hydraulic piston 1320 forward. Accordingly, the hydraulic pressure in the second pressure chamber 1340 is released, and at the same time, a negative pressure may be generated, so that the pressurized medium in the wheel cylinders 20 may be transferred to the second pressure chamber 1340.

Specifically, the hydraulic pressure of the pressurized medium applied to the first wheel cylinder 21 and the second wheel cylinder 22 provided in the first hydraulic circuit 1510 is recovered to the second pressure chamber 1340 by sequentially passing through the sixth hydraulic flow path 1406, the eighth hydraulic flow path 1408, and the tenth flow path 1410. In this case, the fifth valve 1435 provided in the sixth hydraulic flow path 1406 allows only the flow of the pressurized medium discharged from the first hydraulic circuit 1510 so that the pressurized medium may be recovered, and the eighth valve 1438 provided in the tenth hydraulic flow path 1410 is switched to be opened, to thereby allow the flow of the pressurized medium transferred along the tenth hydraulic flow path 1410. In addition, the seventh valve 1437 is controlled to be closed to prevent, suppress, or reduce the recovered pressurized medium from leaking into the first pressure chamber 1330 via the ninth hydraulic flow path 1409. Also, the first inlet valve 1511a and the second inlet valve 1511b provided in the first hydraulic circuit 1510 are maintained in the open state, and the first outlet valve 1512a and the second outlet valve 1512b are maintained in the closed state.

Also, the hydraulic pressure of the pressurized medium applied to the third wheel cylinder 23 and the fourth wheel cylinder 24 provided in the second hydraulic circuit 1520 by the negative pressure generated in the second pressure chamber 1340 is recovered to the second pressure chamber 1340 by sequentially passing through the seventh hydraulic flow path 1407, the eighth hydraulic flow path 1408, and the tenth hydraulic flow path 1410. As described above, since the sixth valve 1436 provided in the seventh hydraulic flow path 1407 allows the flow of the pressurized medium discharged from the second hydraulic circuit 1520, and since the eighth valve 1438 provided in the tenth hydraulic flow path 1410 is opened, the pressurized medium may be smoothly recovered to the second pressure chamber 1340. Furthermore, the seventh valve 1437 is controlled to be closed to prevent the pressurized medium recovered from the first hydraulic circuit 1510 from leaking into the first pressure chamber 1330 through the ninth hydraulic flow passage 1409. The third inlet valve 1521a and the fourth inlet valve 1521b provided in the second hydraulic circuit 1520 are provided in the open state, and the third outlet valve 1522a is maintained in a closed state.

Meanwhile, when the second braking mode is released, the first dump valve 1831 may be opened to implement smooth forward movement of the hydraulic piston 1320, and the second dump valve 1841 may be switched into a closed state such that negative pressure is rapidly generated in the second pressure chamber 1340.

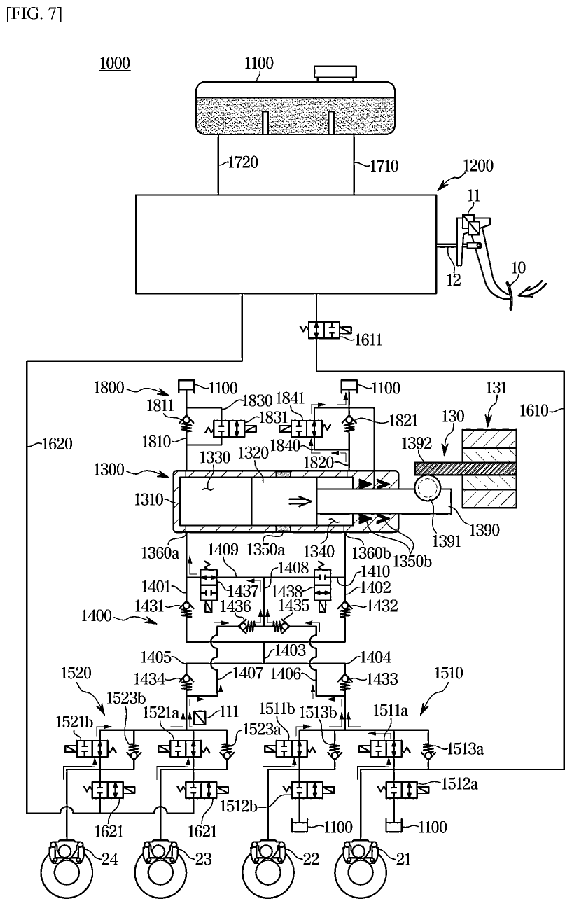

After the releasing of the second braking mode is completed, it may be switched to the releasing operation of the first braking mode illustrated in FIG. 7 in order to completely release the braking pressure applied to the wheel cylinders 20.

FIG. 7 is a hydraulic circuit diagram illustrating a state in which an electronic brake system disables a first braking mode according to an embodiment.

Referring to FIG. 7, the hydraulic piston 1420 of the electronic brake system 1000 may move backward, releasing the first braking mode.

In this case, when the pedal effort applied to the brake pedal 10 is released, the motor generates a rotational force in the other direction and transfers the rotational force to the power conversion unit 130, and the power conversion unit 130 moves the hydraulic piston 1320 backward. Accordingly, a negative pressure may be generated in the first pressure chamber 1330, so that the pressurized medium in the wheel cylinders 20 may be transferred to the first pressure chamber 1330.

Specifically, the hydraulic pressure in the first and second wheel cylinders 21 and 22 provided in the first hydraulic circuit 1510 is recovered to the first pressure chamber 1330 by sequentially passing through the sixth hydraulic flow path 1406, the eighth hydraulic flow path 1408, and the ninth hydraulic flow path 1409. In this case, the fifth valve 1435 provided in the sixth hydraulic flow path 1406 is provided as a check valve for allowing the flow of the pressurized medium discharged from the first hydraulic circuit 1510 so that the pressurized medium may be transferred, and the seventh valve 1437 is opened to allow the flow of the pressurized medium through the ninth hydraulic flow path 1409. The first inlet valve 1511a and the second inlet valve 1511b provided in the first hydraulic circuit 1510 are maintained in the open state, and the first outlet valve 1515a and the second outlet valve 1512b are maintained in the closed state. In addition, the eighth valve 1438 is controlled to a closed state to prevent, suppress, or reduce the recovered pressurized medium from leaking into the second pressure chamber 1340 via the tenth hydraulic flow path 1410, and the first dump valve 1831 operates to be closed so as to effectively form a negative pressure in the first pressure chamber 1330.

The hydraulic pressure of the pressurized medium applied to the third wheel cylinder 23 and the fourth wheel cylinder 24 provided in the second hydraulic circuit 1520 by the negative pressure generated in the first pressure chamber 1330 is recovered to the first pressure chamber 1330 by sequentially passing through the seventh hydraulic flow path 1407, the eighth hydraulic flow path 1408, and the ninth hydraulic flow path 1409. As described above, since the sixth valve 1436 provided in the seventh hydraulic flow path 1407 is provided as a check valve that allows only the flow of the pressurized medium discharged from the second hydraulic circuit 1520, the pressurized medium may be recovered, and the seventh valve 1437 is opened to allow the flow of the pressurized medium through the ninth hydraulic flow path 1409. In addition, the third inlet valve 1521a and the fourth inlet valve 1521b provided in the second hydraulic circuit 1520 are maintained in an open state. Furthermore, the eighth valve 1438 is controlled to be closed to prevent, suppress, and reduce the recovered pressurized medium from leaking into the second pressure chamber 1340 via the tenth hydraulic flow path 1410. The third inlet valve 1521a and the fourth inlet valve 1521b provided in the second hydraulic circuit 1520 are provided in the open state.

At the same time, the second dump valve 1841 is opened to implement rapid and smooth backward movement of the hydraulic piston 1320 such that the pressurized medium accommodated in the second pressure chamber 1340 may be discharged to the reservoir 1100 through the second bypass passage 1840.

By the above-described entry and release operations for the first braking mode, the second braking mode, and the third braking mode, the electronic brake system 1000 according to the embodiment may secure various braking pressures from a low pressure to a high pressure.

On the other hand, when the braking pressure is high, the direction change of the hydraulic piston 1320 may act as a factor to delay securing the braking pressure or to generate noise. Accordingly, it is important to maximize the efficiency of securing the pressure and to minimize the influence of noise due to the direction change of the hydraulic piston 1320.

Hereinafter, the operation of the electronic brake system 1000 according to an embodiment for efficiently securing the braking pressure and effectively controlling the direction change of the hydraulic piston 1320 will be described with reference to FIGS. 8 to 10.

FIG. 8 is a control block diagram illustrating an electronic brake system according to an embodiment. FIGS. 9A and 9B are views illustrating a part of a hydraulic pressure supply device of an electronic brake system according to an embodiment. FIG. 10 is an example of a stroke map used in an electronic brake system according to an embodiment.

Referring to FIG. 8, the electronic brake system 1000 according to an embodiment includes a detector 110, a controller 120 for controlling overall components inside the electronic brake system 1000, a hydraulic pressure supply device 1300, a valve driver 140 for driving at least one valve, and a storage 150.

The detector 110 may include a pressure sensor 111 and a motor position sensor 112.

The pressure sensor 111 may detect the hydraulic pressure of the hydraulic circuits 1510 and 1520, the master cylinder 1200, or the hydraulic pressure supply device 1300. To this end, the pressure sensors 111 may be provided in various numbers at various locations.

The motor position sensor 112 may detect various types of information for estimating the position of the hydraulic piston 1320. The motor position sensor 112 may measure the rotation angle, rotation speed, rotation position, or current of the motor 131. To this end, the motor position sensor 112 may include at least one Hall sensor for detecting the position of the rotor and/or at least one current sensor for detecting the current supplied to the motor 131.

The valve driver 140 may drive at least one valve included in the electronic brake system 1000. The valve driver 140 may open or close various valves of the electronic brake system 1000 based on a control command of the controller 120 to be described below.

The controller 120 may control the valve driver 140 to open or close at least one valve based on an operation mode. Specifically, the controller 120 may control the valve driver 140 to open or close various valves in the electronic brake system 1000 to perform entry or release of the first braking mode, the second braking mode, and/or the third braking mode. As described above, the controller 120 may be configured to, in the first braking mode, allow the hydraulic piston 1320 of the hydraulic pressure supply device 1300 to move in the first direction (forward direction) to generate the hydraulic pressure using the pressurized medium of the first pressure chamber 1330, and in the second braking mode, allow the hydraulic piston 1320 to move in the second direction (backward direction) to generate the hydraulic pressure using the pressurized medium of the second pressure chamber 1340. In addition, the controller 120 may be configured to, in the third braking mode, allow the hydraulic piston 1320 of the hydraulic pressure supply device 1300 to move in the first direction (forward direction) to generate the hydraulic pressure using a difference between the capacity of the first pressure chamber 1330 and the capacity of the second pressure chamber 1340.

The controller 120 may control the motor 131 based on whether a predetermined target pressure is securable so that the direction change of the hydraulic piston 1320 is controlled.

Specifically, in the high-pressure mode, the controller 120 may control the direction change of the hydraulic piston 1320 based on whether the above-described predetermined target pressure is securable.

To this end, the controller 120 may determine the operation mode as a high-pressure mode based on at least one of a hydraulic pressure, a vehicle speed, whether an anti-lock brake System (ABS) control is performed, whether an electronic stability control system (ESC) control is performed, or an input of a user.

Specifically, the controller 120 may determine the operation mode as a high-pressure mode upon satisfying at least one of: a case in which the hydraulic pressure is greater than or equal to a predetermined reference pressure; a case in which the vehicle speed is greater than or equal to a predetermined reference vehicle speed; a case in which an ABS control is performed; a case in which an ESC is performed; or a case in which a user's input is received.

In this case, the reference pressure may refer to a level of hydraulic pressure based on which the second braking mode is switched to the third braking mode, but is not limited thereto and may include various pressure values according to embodiments. The user input may be received from an input device (not shown) provided in the vehicle, and the controller 120 may receive the user input from the input device (not shown).

Meanwhile, the high-pressure mode is an operation mode set separately from the first to third braking modes described above with reference to FIGS. 1 to 7, and the controller 120 according to the embodiment may perform the entry or release operation for the first braking mode to the third braking mode together with an operation in the high-pressure mode.

The following description is made in relation to an operation of the controller 120 when the detected hydraulic pressure is greater than or equal to the predetermined reference pressure as an example.

When the detected hydraulic pressure is greater than or equal to or equal to the predetermined reference pressure, the controller 120 may control the direction change of the hydraulic piston 1320 based on whether a predetermined target pressure is securable.

When the hydraulic pressure of the hydraulic circuits 1510 and 1520 is greater than or equal to the predetermined reference pressure, the controller 120 may determine whether a predetermined target pressure is securable. For example, when the hydraulic pressure of the hydraulic circuits 1510 and 1520 is greater than or equal to 100 bar, the controller 120 may determine whether a predetermined target pressure is securable without changing the moving direction of the hydraulic piston 1320.

In addition, the target pressure may be predetermined as a value for which the spare volume of the hydraulic piston 1320 is usable when controlling the hydraulic pressure of high pressure, for example, may be set to 50 bar.

To this end, the controller 120 may determine whether the predetermined target pressure is securable based on the position of the hydraulic piston 1320. In this case, the controller 120 may identify the position of the hydraulic piston 1420 based on data transmitted from the detector 110.

For example, the controller 120 may determine a target stroke change amount of the hydraulic piston 1320 for securing the predetermined target pressure, and may identify whether the predetermined target pressure is securable based on the position of the piston and the target stroke change amount.

In this case, the controller 120 may determine the target stroke change amount required to secure the predetermined target pressure from a current pressure based on a previously stored hydraulic characteristic map. In this case, the hydraulic characteristic map may include a characteristic map of a stroke and a hydraulic pressure of the hydraulic piston 1320 in consideration of a required liquid amount.

For example, as shown in FIG. 10, the controller 120 may identify a minimum stroke value S2 required to secure a pressure greater than or equal to a predetermined target pressure Pt from a current pressure P1 based on the hydraulic characteristic map. The controller 120 may determine a target stroke change amount ΔS based on a current stroke value S1 and the minimum stroke value S2, and determine that the target stroke change amount ΔS corresponds to the target pressure Pt.

The controller 120 may determine a reference range based on the target stroke change amount. In this case, the reference range may refer to a range for the position of the hydraulic piston 1320 in which the target pressure is securable.

Specifically, the controller 120 may determine the reference range based on the target stroke change amount and the moving direction of the hydraulic piston 1320.

For example, as shown in FIGS. 9A and 9B, when the moving direction of the hydraulic piston 1320 is the forward direction, the controller 120 may determine a range in a direction opposite to the moving direction with respect to a minimum reference position R1 for securing the target stroke change amount ΔS as the reference range T. That is, the controller 120 may determine the range in a direction toward the second pressure chamber 1340 with respect to the minimum reference position R1 as the reference range T in which the target stroke change amount ΔS is securable.

In this case, when the position of the hydraulic piston 1320 is within the reference range T in which the target stroke change amount is securable in the moving direction of the piston 1320, the controller 120 may determine that the predetermined target pressure is securable.

For example, as shown in FIG. 9A, when the moving direction of the hydraulic piston 1320 is the forward direction, and the hydraulic piston 1320 is located at a position Xa within the reference range T in which the target stroke change amount ΔS is securable in the moving direction of the hydraulic piston 1320, the controller 120 may confirm that the predetermined target pressure is securable.

As another example, as shown in FIG. 9B, when the moving direction of the hydraulic piston 1320 is the forward direction, and the hydraulic piston 1320 is located at a position Xb outside the reference range T in which the target stroke change amount ΔS is securable in the moving direction of the hydraulic piston 1320, the controller 120 may confirm that the predetermined target pressure is not securable.

When the predetermined target pressure is securable, the controller 120 may control the motor 131 so that the moving direction of the hydraulic piston 1320 is maintained. Specifically, the controller 120 may maintain the direction of rotation of the motor 131 to maintain the moving direction of the hydraulic piston 1320.

When the predetermined target pressure is not securable, the controller 120 may control the motor 131 so that the moving direction of the hydraulic piston 1320 is switched. Specifically, the controller 120 may change the direction of rotation of the motor 131 to the opposite direction to change the moving direction of the hydraulic piston 1320.

With such a configuration, the controller 120 may continuously secure the braking pressure, so that the high-pressure braking pressure may be more efficiently secured. At the same time, since the noise caused by the direction change of the hydraulic piston 1320 is minimized, so that the user's convenience may be increased.

In addition, the controller 120 may determine the moving direction of the hydraulic piston 1320 for applying the high-pressure braking pressure to the wheel cylinders 21, 22, 23, and 24 based on whether the predetermined target pressure is securable.

That is, the controller 120 may determine the moving direction of the hydraulic piston 1320 for delivering hydraulic pressure to the wheel cylinders 21, 22, 23, and 24 based on whether the predetermined target pressure is securable, and may control the motor 131 to move the hydraulic piston 1320 in the determined moving direction.

In this case, when the hydraulic pressure transmitted to the wheel cylinders 21, 22, 23, and 24 by the movement of the hydraulic piston 1320 is greater than or equal to the predetermined reference pressure, the controller 120 may determine whether the predetermined target pressure is securable based on the position of the hydraulic piston 1320. The controller 120 may control the direction change of the hydraulic piston 1320 based on whether the predetermined target pressure is securable, to determine the moving direction of the hydraulic piston 1320. Descriptions thereof are the same as described above.

With such a configuration, when the target pressure is securable, the controller 120 may increase the braking pressure while maintaining the moving direction of the hydraulic piston 1320. When the target pressure is not securable, the controller 120 may increase the braking pressure while changing the direction of the hydraulic piston 1320 to the opposite direction.

Accordingly, when the target pressure is securable, the braking pressure may be continuously secured, so that the high-pressure braking pressure may be more efficiently secured. At the same time Since the direction change of the hydraulic piston 1320 is performed only when the target pressure is not securable, the noise caused by the direction change of the hydraulic piston 1320 may be minimized, so that the user's convenience may be increased.

The controller 120 may be implemented by a memory 122 for storing data regarding an algorithm for controlling the operations of the components of the electronic brake system 1000 or a program that represents the algorithm, and a processor 121 that performs the above-described operations using the data stored in the memory 122. In this case, the memory 122 and the processor 121 may be implemented as separate chips. Alternatively, the memory 122 and the processor 121 may be implemented as a single chip.

The storage 150 may store various types of information, including a characteristic map of hydraulic pressure, utilized in the electronic brake system 1000.

To this end, the storage 150 may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random-access memory (RAM), or other storage media, such as a hard disk drive (HDD), a CD-ROM, and the like., but the implementation of the storage 150 is not limited thereto. The storage 150 may be a memory 122 implemented as a chip separated from the processor 121, which has been described above in connection with the controller 120, or may be implemented as a single chip integrated with the processor 121.

Meanwhile, at least one component may be added or omitted to correspond to the performances of the components of the electronic brake system 1000 shown in FIG. 8. In addition, the mutual positions of the components may be changed to correspond to the performance or structure of the system.

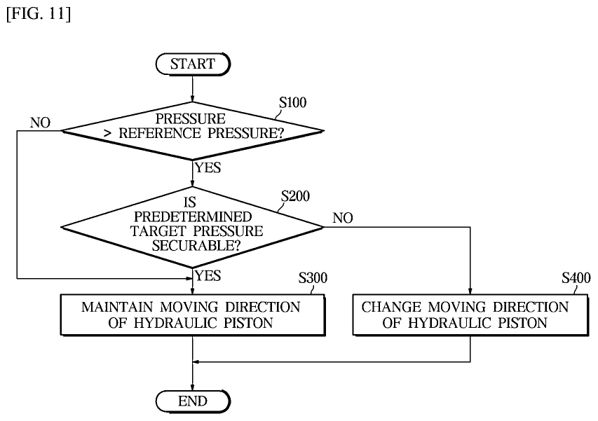

FIG. 11 is a flowchart showing a method of controlling an electronic brake system according to an embodiment.

Referring to FIG. 11, the electronic brake system 1000 according to an embodiment may determine whether the pressure of the hydraulic circuits 1510 and 1520 is greater than or equal to a predetermined reference pressure (S100). In this case, the predetermined reference pressure may be set in advance as a reference pressure for checking a high-pressure hydraulic pressure.

When the pressure is not greater than or equal to the predetermined reference pressure (No in operation S1), the electronic brake system 1000 may maintain the moving direction of the hydraulic piston 1320 (S300).

When the hydraulic pressure of the hydraulic circuits 1510 and 1520 is not greater than or equal to the predetermined reference pressure, it may be expected that a sufficient distance remains for the hydraulic piston 1320 to move in the current moving direction. In addition, when the hydraulic pressure of the hydraulic circuits 1510 and 1520 is not greater than or equal to the predetermined reference pressure, it may be expected that the load applied to the motor does not increase rapidly.

Therefore, when the hydraulic pressure of the hydraulic circuits 1510 and 1520 is not greater than or equal to the predetermined reference pressure, the electronic brake system 1000 may control the motor such that the hydraulic piston 1320 moves to the maximum movement position within the pressure chambers 1330 and 1340, thereby suppressing frequent switching of the moving direction of the hydraulic piston 1320.

When the pressure is greater than or equal to the predetermined reference pressure (YES in operation S1), the electronic brake system 1000 may determine whether a predetermined target pressure is securable (S200). In this case, the target pressure may be predetermined as a value for which the spare volume of the hydraulic piston 1320 is usable when controlling the high-pressure hydraulic pressure, for example, may be set to 50 bar.

To this end, the electronic brake system 1000 may determine whether the predetermined target pressure is securable based on the position of the hydraulic piston 1320. In this case, the electronic brake system 1000 may identify the position of the hydraulic piston 1420 based on data transmitted from the detector 110.

Specifically, the electronic brake system 1000 may determine a target stroke change amount of the hydraulic piston 1320 for securing the predetermined target pressure, and may determine whether the predetermined target pressure is securable based on the position of the piston and the target stroke change amount.

In this case, the electronic brake system 1000 may determine the target stroke change amount required to secure the predetermined target pressure from a current pressure based on a previously stored hydraulic characteristic map. In this case, the hydraulic characteristic map may include a characteristic map of a stroke and a hydraulic pressure of the hydraulic piston 1320 in consideration of a required liquid amount.

For example, the electronic brake system 1000 may identify a minimum stroke value required to secure a pressure greater than or equal to a predetermined target pressure from a current pressure based on the hydraulic characteristic map. The electronic brake system 1000 may determine a target stroke change amount based on a current stroke value and the minimum stroke value, and determine that the target stroke change amount corresponds to the target pressure.

The electronic brake system 1000 may determine a reference range based on the target stroke change amount. In this case, the reference range may refer to a range for the position of the hydraulic piston 1320 in which the target pressure is securable.

Specifically, the electronic brake system 1000 may determine the reference range based on the target stroke change amount and the moving direction of the hydraulic piston 1320.

For example, when the moving direction of the hydraulic piston 1320 is the forward direction, the electronic brake system 1000 may determine a range in a direction opposite to the moving direction based on a minimum reference position for securing the target stroke change amount as the reference range. That is, the electronic brake system 1000 may determine the range in a direction toward the second pressure chamber 1340 with respect to the minimum reference position as the reference range in which the target stroke change amount is securable.

In this case, when the position of the hydraulic piston 1320 is within the reference range in which the target stroke change amount is securable in the moving direction of the piston 1320, the electronic brake system 1000 may determine that the predetermined target pressure is securable.

When the predetermined target pressure is securable (YES in operation S200), the electronic brake system 1000 may maintain the moving direction of the hydraulic piston 1320 (S300). Specifically, the electronic brake system 1000 may maintain the direction of rotation of the motor 131 to maintain the moving direction of the hydraulic piston 1320.

For example, when the moving direction of the hydraulic piston 1320 is the forward direction, the electronic brake system 1000 may control the hydraulic piston 1320 to continuously move in the forward direction.

As another example, when the pressure is less than the predetermined reference pressure (No in operation S1) or the predetermined target pressure is not securable (No in operation S200), the electronic brake system 1000 may change the moving direction of the hydraulic piston 1320 (S400). Specifically, the electronic brake system 1000 may change the direction of rotation of the motor 131 to change the moving direction of the hydraulic piston 1320.

With such a configuration, since the controller 120 may continuously secure the braking pressure, the high-pressure braking pressure may be more efficiently secured. At the same time, since the noise caused by the direction change of the hydraulic piston 1320 is minimized, so that the user's convenience may be increased.

Although few embodiments of the present invention have been shown and described, the above embodiment is illustrative purpose only, and it would be appreciated by those skilled in the art that changes and modifications, which have not been illustrated above, may be made in these embodiments without departing from the principles and scope of the invention, the scope of which is defined in the claims and their equivalents.

1. An electronic brake system comprising:
a hydraulic pressure supply device including a motor, and configured to generate a hydraulic pressure by rotating the motor to move a piston in a first direction or a second direction;
a hydraulic circuit configured to guide the hydraulic pressure generated by the hydraulic pressure supply device to a wheel cylinder;
a motor position sensor configured to detect a rotation of the motor;
a pressure sensor configured to detect a hydraulic pressure of the hydraulic circuit; and
a controller configured to identify a position of the piston based on the rotation of the motor, and if the detected hydraulic pressure is greater than or equal to a reference pressure, identify whether a target pressure is securable based on the position of the piston, and control a direction change of the piston based on whether the predetermined target pressure is securable.

2. The electronic brake system of claim 1, wherein the controller is configured to: identify a target stroke change amount of the piston for securing the target pressure, and identify whether the predetermined target pressure is securable based on the position of the piston and the target stroke change amount.

3. The electronic brake system of claim 2, wherein the controller is configured to, if the position of the piston is located within a reference range in which the target stroke change amount is securable in a moving direction of the piston, identify that the target pressure is securable.

4. The electronic brake system of claim 3, wherein the controller is configured to determine a range in a direction opposite to the moving direction of the piston with respect to a reference position for securing the target stroke change amount as the reference range in which the target stroke change amount is securable.

5. The electronic brake system of claim 2, further comprising a storage configured to store a characteristic map of a stroke of the piston and hydraulic pressure,
wherein the controller is configured to determine the target stroke change amount of the piston corresponding to the target pressure based on the characteristic map.

6. The electronic brake system of claim 1, wherein the controller is configured to, if the target pressure is securable, control the motor such that the moving direction of the piston is maintained.

7. The electronic brake system of claim 1, wherein the controller is configured to, if the target pressure is not securable, control the motor such that the moving direction of the piston is changed.

8. The electronic brake system of claim 1, wherein the controller is configured to determine whether the target pressure is securable based on the position of the piston if a vehicle speed is greater than or equal to a predetermined reference speed.

9. The electronic brake system of claim 1, wherein the controller is configured to determine whether the target pressure is securable based on the position of the piston if an anti-lock brake system (ABS) control or an electronic stability control system (ESC) control is performed.

10. The electronic brake system of claim 1, wherein the controller is configured to determine whether the target pressure is securable based on the position of the piston if a user input is received.

11. The electronic brake system of claim 1, wherein the controller is configured to determine whether the target pressure is securable based on the position of the piston if a hydraulic pressure of a pressurized medium discharged as the piston moves in a forward direction is greater than or equal to the reference pressure.

12. The electronic brake system of claim 1, wherein the hydraulic circuit further includes a hydraulic control unit including a first hydraulic circuit configured to control a hydraulic pressure transferred to a first wheel cylinder and a second hydraulic circuit configured to control a hydraulic pressure transferred to a second wheel cylinder, and
wherein the hydraulic control unit includes a first valve configured to control a flow of pressurized medium from a first pressure chamber located at one side of the piston and a second valve configured to control a flow of pressurizing medium from a second pressure chamber located at an other side of the piston.

13. The electronic brake system of claim 12, further comprising a valve driver configured to open or close the first and second valves, and
wherein the controller is configured to, if the detected hydraulic pressure is greater than or equal to the reference pressure, control the valve driver to open the first valve and the second valve.

14. An electronic brake system comprising:
a hydraulic pressure supply device including a motor, and configured to generate a hydraulic pressure by rotating the motor to move a piston in a first direction or a second direction;
a hydraulic circuit configured to guide the hydraulic pressure generated by the hydraulic pressure supply device to a wheel cylinder;
a motor position sensor configured to detect a rotation of the motor; and
a controller configured to, if an operation mode is a high-pressure mode, determine whether a predetermined target pressure is securable based on a position of the piston, determine a moving direction of the piston for transferring a hydraulic pressure to the wheel cylinder based on whether the predetermined target pressure is securable, and control the hydraulic pressure supply device to move the piston in the determined moving direction.

15. The electronic brake system of claim 14, further comprising a pressure sensor configured to detect a hydraulic pressure of the hydraulic circuit,
wherein the controller is configured to determine the operation mode as the high-pressure mode based on at least one of the detected hydraulic pressure, a vehicle speed, whether an anti-lock brake system (ABS) control is performed, whether an electronic stability control system (ESC) control is performed, or an input of a user.

16. The electronic brake system of claim 14, wherein the hydraulic circuit includes:
a first valve configured to control a flow of pressurized medium from a first pressure chamber located at one side of the piston and a second valve configured to control a flow of pressurizing medium from a second pressure chamber located at an other side of the piston.

17. The electronic brake system of claim 16, further comprising a valve driver configured to open or close the first and second valves,
wherein the controller is configured to, if the hydraulic pressure is greater than or equal to a predetermined reference pressure, control the valve driver to open the first valve and the second valve.

18. A method of controlling an electronic brake system, the method comprising:
generating a hydraulic pressure by rotating a motor to move a piston in a first direction or a second direction;
detecting rotation of the motor;
detecting the generated hydraulic pressure;
identifying a position of the piston based on the rotation of the motor;
if the detected hydraulic pressure is greater than or equal to a reference pressure, identifying whether a target pressure is securable based on the position of the piston; and
changing a moving direction of the piston based on whether the predetermined target pressure is securable.

19. The method of claim 18, wherein the identifying of whether the target pressure is securable includes:
identifying a target stroke change amount of the piston for securing the target pressure; and
identifying whether the target pressure is securable based on the position of the piston and the target stroke change amount.

20. The method of claim 18, wherein the changing of the moving direction of the piston includes:
if the target pressure is securable, controlling the motor such that the moving direction of the piston is maintained; and
if the target pressure is not securable, controlling the motor such that the moving direction of the piston is changed.
